(19) United States
(12) Patent Application Publication
(10) Pub. No.: US 2025/0193976 A1
(43) Pub. Date: Jun. 12, 2025

(54) MICROWAVE OVEN WITH REDISTRIBUTING ELEMENT

(71) Applicant: SOCIETE DES PRODUITS NESTLE S.A., Vevey (CH)

(72) Inventor: Ulrich Johannes ERLE, Cleveland, OH (US)

(21) Appl. No.: 18/971,541

(22) Filed: Dec. 6, 2024

Related U.S. Application Data
(60) Provisional application No. 63/607,656, filed on Dec. 8, 2023.

(51) Int. Cl. H05B 6/72

(52) U.S. Cl. CPC H05B 6/72

(57) ABSTRACT

A microwave oven for heating a food product such as a lasagna. The microwave oven comprises: two solid state microwave sources for generating microwaves, two microwave emitters arranged to emit the microwaves generated by the solid state microwave sources, a cavity defining a space for receiving the food product, wherein the space is arranged between the microwave emitters, and a redistributing element arranged to redistribute the microwaves emitted by at least one of the microwave emitters into the space towards one or more defined target areas of the space.

### CROSS-REFERENCE TO RELATED APPLICATION

This application claims priority to and any benefit of U.S. Provisional Application No. 63/607,656, filed Dec. 8, 2023, the content of which is incorporated herein by reference in its entirety.

### TECHNICAL FIELD

The invention is in the area of quick cooking ovens. The invention relates to a microwave oven for heating a food product such as a frozen lasagna, a kit comprising such a microwave oven, and a method for heating a food product such as a frozen lasagna.

### BACKGROUND ART

To offer a cooking functionality for frozen food, a microwave oven may be with or without an additional heat source. A microwave oven may have a so-called ‘multimode’ cavity. This design philosophy tries to achieve even microwave heating by creating a multitude of standing wave modes in the cavity and move the food through the hot and cold areas by means of a turntable. Alternatively, a mode stirrer may be used for a similar effect.

While microwaves already speed up the cooking compared to conventional cooking, some key issues remain, especially when cooking a large portion of frozen food. Despite the product movement, there is a clear tendency in most microwave ovens to heat up the edges of the food container first, leading to a pronounced runaway effect. This means that as soon as some portion of the food product has melted, that portion will now absorb microwaves far better than the part that is still frozen. As a result, the cook time for a large frozen food item is much longer than necessary, since much of the energy goes into boiling off water from the edges as opposed to melting and heating the core. Using more microwave power does not solve this. Even powerful ovens are not able to cook a frozen family size food product, such as a lasagne, in less than 25 minutes; at least, such ovens are not able to cook said food product without sacrificing important product attributes.

Using solid state technology, a microwave oven no longer produces microwaves by a magnetron but by transistors. Solid state technology offers much improved control over the microwave frequency and therefore over the field distribution in the cavity. However, such microwave ovens have multimode cavities, making it almost impossible to know the exact electrical field distribution in all phases of the cooking process. Moreover, these ovens have to be able to cook very diverse foods, which makes it harder to tailor the electrical field to the geometry of the cavity and the food. As a result of these complications, even solid state technology, when combined with a multimode cavity, will still show runaway heating on the outside of a large frozen food product while not heating the core sufficiently.

One cavity design makes use of solid state technology but goes one step further in that the cavity is a mono-mode cavity that avoids strong electrical fields around the edges of the food container. The cavity has been designed primarily to allow for a vertical shift of the hot spot with the idea to selectively heat the upper or lower part of a stack of food compartments (‘zoning’). While the cavity achieves this goal and can therefore also be used to heat the core of a frozen food product before the edges, it can be seen in the respective infrared images that the size of the hot spot in the two horizontal dimensions is not big enough to provide even heating throughout the container. The use of this cavity for quick defrosting has also been studied. For this purpose, two lateral channels of microwave were activated and helped to guide additional energy to the edges.

Accordingly, there is a need to cook a food product both quicker and such that an even heating throughout the food product is achieved.

### SUMMARY OF THE INVENTION

According to a first aspect, a microwave oven for heating a food product such as a frozen lasagna is provided. The microwave oven comprises: two solid state microwave sources for generating microwaves; two microwave emitters arranged to emit the microwaves generated by the solid state microwave sources; a cavity defining a space for receiving the food product, wherein the space is arranged between the microwave emitters; and a redistributing element arranged to redistribute the microwaves emitted by at least one of the microwave emitters into the space towards one or more defined target areas of the space.

The defined redistribution of the microwaves by the redistributing element(s) achieves the advantage that one or more defined areas of a food product within the space can be exposed to a defined extent of the radiation of the microwaves. Therefore, a too low heating of these areas can be avoided, whereby a quicker cooking of and more even heating throughout the food product can be achieved.

In particular, by the redistributing element being arranged to redistribute the microwaves emitted by the at least one of the microwave emitters into the space towards the one or more defined target areas of the space, the redistributing element is arranged to modify the electrical field strength in the space between the microwave emitters.

The redistributing element is thus an element dedicated for redistributing the microwaves emitted by the at least one of the microwave emitters in a defined manner, namely towards the one or more defined target areas of the space. In other words, an element not dedicated for such a redistribution in a defined manner, such as a reflecting wall delimiting the space and/or a mode stirrer, is not a redistributing element in the sense of the present invention.

For example, the space is delimited by one or more (reflecting) walls, such as a bottom, one or more sidewalls, and/or a top, wherein the redistributing element is arranged within the space.

The redistributing element may be made of a non-metallic and/or microwave transparent material, such as a microwave transparent plastic and/or a ceramic material and/or a glass material. By a ceramic material, the redistributing element may be made thinner. In particular, a ceramic material may have higher values for the dielectric constant (e.g. when compared to a glass material), enabling a thinner redistributing element.

In an embodiment, the redistributing element is made of a material having, at a frequency of 1 MHz of the microwaves, a (real part of the) dielectric constant in a range of 3 to 4, in particular in a range of 3 to 3.3, such as 3.15, or in a range of 3.5 to 3.9, such as 3.7; for example, the dielectric constant of 3.7 may be achieved by glass or by glass fillers in the plastic.

In an embodiment, the redistributing element is arranged to redistribute the emitted microwaves so as to be focused and/or dispersed, such as fanned out, in the space.

In an embodiment, the redistributing element is arranged between at least one microwave emitter of the (at least two) microwave emitters on the one hand and the space and/or one or more defined target areas on the other hand.

In an embodiment, the redistributing element comprises, or may be, a lens. Thus, a particularly fast cooking of and even heat distribution in the food product can be achieved.

In an embodiment, the lens comprises: a convex section for focusing microwaves emitted by the at least one of the microwave emitters; and/or a concave section for dispersing, such as fanning out, microwaves emitted by the at least one of the microwave emitters.

In an embodiment, the lens comprises a backside and a front side, wherein the front side faces the space and comprises the convex and concave sections. The backside may be flat. For example, a flat backside makes it easy to mount the lens, such as by sliding the lens in and out of its support or mount.

In an embodiment, the convex section is arranged at least laterally with respect to the concave section and/or surrounds the concave section. The convex section may be an outer section, wherein the concave section may be an inner section. For example, the convex section may have the form of a ring, such as circular, a rectangular or a polygonal ring.

In an embodiment, the concave section comprises, or consists of, two sub sections that may be respectively flat. The sub sections may be inclined with respect to one another at an angle greater than 90°, preferably greater than 135°, more preferably greater than 150°. By providing these sections as flat sections, the lens can be easily manufactured. In another embodiment, however, these sections may be non-flat, i.e. respectively without a flat surface, such as with a curved surface.

In an embodiment, the lens is plane symmetric, such as plane symmetric with respect to a symmetry plane extending through a center of the concave section. For example, the symmetry plane may be between the sub sections.

In an embodiment, the microwave oven comprises a spacer arranged to provide a defined distance between the redistributing element and a food product arranged within the space. The spacer provides a distance between the redistributing element the food product such that microwaves redistributed by the redistributing elements evenly heat the food product. Further, the spacer provides thermal insulation from the body of the redistributing element, which will be hot due to the oven being pre-heated. By the spacer, direct contact of the food product with the hot lens can be avoided, thereby achieving a particularly successful heating of the food product, in particular without an undesired premature melting of the food product. Thus, the risk of derailing the concept of creating a hot spot in the center can be reduced.

Additionally, or alternatively, the microwave oven comprises a suspension to suspend the food (e.g. in the same position as done by the spacer), such as one or more plastic rods, e.g. mounted to the side walls, or a metal wire shelf, wherein the metal wire may be perpendicular to the electric field.

In an embodiment, the spacer is connected to, and/or received by, the redistributing element. For example, the redistributing element may comprise a recessed portion (such as a notch) in which the spacer is received. The recessed portion may extend both in the convex section and the concave section, e.g. transversely with respect to a groove defined by the sub sections.

The spacer may be arranged such that the food product can be placed directly on the spacer when the food product is arranged in the space for being heated by the microwave oven.

In an embodiment, the cavity is a non-resonant cavity. In other words, for example the size and shape of the cavity is designed to provide a cavity in which microwaves generated by the solid state microwave sources do not resonate. This means that no resonance peak can be observed within the cavity in a frequency sweep as long as the frequencies remain in the respective ISM band (e.g., in a range of 902-928 MHz) for which the cavity is designed. The prevailing mode of the electrical field in this case is not the result of the cavity walls. It is instead mainly caused by the modes of the waves entering the cavity from the two emitters and by the effect of the redistributing element(s). It can be said that this oven design enables the occurrence of one well-defined electrical field distribution, although the cavity as such is not a single mode cavity.

According to a further embodiment a similar cavity may also be designed for ISM bands of 434 MHz, 2.45 GHz or 5.8 GHz.

In an embodiment, the space contains the food product, wherein the cavity and the food product form a non-resonant system. The non-resonant system may be such that no resonance peak can be observed in a frequency sweep as long as the frequencies remain in the respective ISM band, such as in a range of 902-928 MHz.

In an embodiment, the cavity is a single-mode (or mono-mode) microwave cavity, and/or the microwave emitters are each designed to carry only a single mode of microwaves. As such, the cavity is not a multi-mode cavity, whereby the microwaves present in the space are not randomly distributed but rather provided in a very defined manner for advantageously heating the food product.

The microwave emitters may be designed such that the microwaves are emitted into the space along only one (a predominant) direction. This achieves the advantage that the redistributing element can bring about a particularly defined distribution of microwaves, and thus heating pattern, in the space.

By the microwave emitters (e.g. each comprising a waveguide and/or an antenna such as a horn antenna), two travelling microwaves may meet (and thus superimpose) in the cavity or space, where they can cause a defined heating pattern.

In an embodiment, the redistributing element comprises two redistributing elements, wherein each of the redistributing elements is arranged to redistribute the microwaves emitted by a respective one of the microwave emitters into the space towards one or more defined target areas of the space.

Preferably, two redistributing elements (e.g., lenses) and the space, in which the food product can be arranged, are arranged in a symmetrical way, e.g. with a symmetry plane extending through the space and between the redistributing elements. For example, the food product is initially frozen, whereby it does not absorb all microwaves in one pass. The portion of the microwaves that makes it through the food product is collected by the opposing redistributing element and channeled through the opposing microwave emitter (e.g. comprising a waveguide) to leave the cavity. This effect helps to keep unwanted reflections on the cavity walls and the resulting undefined field distributions to a minimum.

The redistributing element may be detachably arranged. The lens may be detachably arranged by a sliding, snap and/or screw connection. In an embodiment, the microwave oven or cavity comprises a support on which the redistributing element is detachably arranged. Therefore, the redistributing element can be easily removed from the remainder of the microwave oven, such as by moving the redistributing element through an opening through which also the food product can be removed when cooked. Once the redistributing element is removed, the redistributing element can be maintained (e.g., cleaned) or another redistributing element for another food product can be attached to the support.

The support may be a wall (such as a top wall, a bottom wall or a sidewall) delimiting the space, or may be attached (e.g. permanently) to such a wall.

In an embodiment, the support comprises one or more guide rails. Thus, the redistributing element can be detached from the support, and thus removed from the remainder of the microwave oven, by a simple sliding movement. The one or more guide rails may extend along a direction extending through the opening through which the food product is placed in, or removed from, the microwave oven.

In an embodiment, the microwave oven comprises a heating device arranged to transfer heat into the space, e.g. by convection and/or radiation, such as by delivering hot air into the space. As such, the time for properly heating the food product can be even further reduced. Further, the heating device aids in that a particularly good heat distribution is brought about by the microwaves in the food product. Another purpose of adding such a supplemental heating device is creating a heat effect different from that of the microwaves. For instance, infrared radiation and hot air can provide browning and crisping, whereas microwaves generally do not.

In an embodiment, the microwave oven comprises a control unit configured to control at least the solid state microwave sources and, optionally, also the heating device. The control unit may be configured to control the solid state microwave sources to operate in different, consecutive phases with different powers and/or phase angles, respectively.

In an embodiment, the control unit is configured to adjust a phase angle between the microwaves emitted by one of the solid state microwave sources and the microwaves emitted by the other one of the solid state microwave sources. This means that, for example, the control unit delays the emission of microwaves generated by one of the solid state microwave sources. As such, a constructive interference between the two microwaves can be created at a desired level within the space. Thereby, a standing microwave can be generated in the space, having a zone providing high microwave energy (i.e. in an area between two nodes of the standing wave), so that this zone can be used for heating a specific region of the food product (e.g. at center height of the food product) in a particularly quick manner. By adjusting said phase angle, the zone may be repositioned (e.g. moved up or down), exposing a different region of the food product to the high microwave energy.

By an adjustment of the phase angle, a hot spot may be created in the center of the food product, leading to a large, melted area in the middle of the food product, e.g. at an intermediate stage of the cooking process. This area will start to conduct heat to the neighboring areas and lead to a more and more pronounced microwave absorption in the center, which will grow from inside out as the heating progresses. Simultaneously, the food product (such as a lasagna) will start to heat at the edges, mainly as a result of the additional heat source. Those edges that are parallel to the electrical field will experience preferential heating to the extent that an electrical field is present.

In an embodiment, the control unit is configured to control the microwaves emitted by one of the solid state microwave sources and the microwaves emitted by the other one of the solid state microwave sources such that they (the microwaves) have the same frequency (coherence). Thereby, a standing microwave can be generated within the space, which is advantageous for heating the food product.

In an embodiment, the control unit is configured to control, e.g. in a specific phase, the microwaves emitted by one of the solid state microwave sources and the microwaves emitted by the other one of the solid state microwave sources such that they (the microwaves) have different frequencies (i.e., no coherence). For example, said specific phase may be towards, or at, the end of the cooking process, when coherence may be no longer necessary. This is because the waves cannot meet anymore due to the much stronger absorption occurring in the warm food product. In this phase, the heating of the food by microwaves occurs more or less in a separated way, whereby the upper microwave emitter (channel) heats the top and the lower microwave emitter (channel) heats the bottom.

For example, for the purpose of quick defrosting and cooking of frozen food, the best position for the hot spot may be in the center height of the food. Later, a different phase angle may be more advantageous. This can be the case, when the wavelength in the food contracts as a result of the melted area and its higher permittivity. In this scenario, two or three areas of constructive interference may occur within the food, and it may be advantageous to choose a phase angle with only two such areas.

In an embodiment, the control unit is configured to switch the solid state microwave sources into an activated state comprising the different phases and to switch the solid state microwave sources into a deactivated state upon the lapse of some time. Such a configuration has been found as particularly advantageous for transferring a frozen food product (such as a lasagna) into a cooked state having a satisfactory temperature throughout the product for consumption.

For example, the different phases may be more than two phases and/or not more than five phases. Each of the different microwave powers may be greater than 700 Watts and/or not more than 2000 Watts, preferably not more than 1500 Watts. Each of the different phases may last for two or more minutes, but preferably not longer than eight minutes.

The control unit may be configured to control the solid state microwave sources such that the microwave sources are synchronized with one another and/or coordinated with respect to a heating, such as hot air convection, by the heating device.

The control unit may be configured to ensure that space is pre-heated, e.g. to 150° C. To ensure this, the control unit may be configured such that an activation of the solid state microwave sources, and thus the emission of microwaves, is prevented until a defined temperature for the pre-heated state (such as 150° C.) is reached. The heat for pre-heating may come from the heating device.

Preferably, no convection is used in a first phase (or stage) of the cooking process using the microwave oven. In this phase, the goal may be to strongly heat the center of the food product. In a second phase (or stage) after the first phase, the heating device may transfer heat by convection, when microwave heating is no longer needed in the center of the food product. Although in the second phase microwaves are still present and continue to inject more energy into the food, the convection can ensure that heat reaches all the surfaces, from where the heat can diffuse inward into the food product.

The microwave oven may comprise a turning mechanism (such as a (e.g. microwave transparent) table, e.g. turntable, or a gripper) arranged to turn the food product in the space by a defined angle, such as 90°. The axis of rotation about which the turning mechanism turns the food product may be parallel to a height axis of the microwave oven and/or to an axis extending within, or through, both of the microwave emitters. By the turning mechanism, any preferential coupling of microwaves to the edges parallel to the electrical field can be alleviated.

In an embodiment, the control unit is configured to control the turning mechanism, for example such that the turning mechanism turns the food product by the defined angle between two of the different phases.

According to a second aspect, a kit is provided. The kit comprises a microwave oven as described above and a plurality of different, interchangeable redistributing elements for obtaining different heating patterns. In particular, the different redistributing elements may provide different microwave beam paths for heating different food products. By the kit, different heating characteristics in the space, or at the target area(s), can be obtained by simple replacement of the redistributing element.

According to a third aspect, a method for heating a food product such as a lasagna is provided. The method comprises the following steps: generating, by two solid state microwave sources, microwaves; emitting, by two microwave emitters, the microwaves generated by the solid state microwave sources; and redistributing, by a redistributing element, the microwaves emitted by at least one of the microwave emitters towards one or more defined target areas of the food product.

### BRIEF DESCRIPTION OF THE DRAWINGS

Exemplary embodiments of the invention are now further explained with respect to the drawings by way of example only, and not for limitation. In the drawings:

FIG. 1 shows a schematic perspective view of a microwave oven according to an embodiment;

FIG. 2 shows a schematic perspective view of an exemplary redistributing element used in the microwave oven shown in FIG. 1;

FIG. 3 shows a schematic perspective view of a microwave oven according to an embodiment;

FIG. 4 shows a schematic perspective view of a microwave oven according to an embodiment;

FIG. 5 shows a method according to an embodiment;

FIGS. 6A-6D show schematically the results of numerical simulations including the different temperature distributions in different states of a food product heated by a microwave oven according to an embodiment: (a) after 5 min microwave exposure, (b) after 10 min microwave exposure, (c) after 15 min microwave exposure, (d) after 15 min microwave exposure and 5 min wait time without heating;

FIG. 7 shows a schematic perspective view of a lasagna heated by a microwave oven according to the example;

FIG. 8 shows the temperature distribution at mid level of the lasagna shown in FIG. 7;

FIG. 9 shows the temperature distribution at mid level of a lasagna heated by a microwave oven without any redistributing element (comparative example); and

FIGS. 10A-10C show a microwave oven according to an embodiment with a lasagna therein, see FIG. 10A, and diagrams, see FIGS. 10B and 10C, showing the amounts of the (simulated, wherein the simulations were carried out for each emitter (channel) separately) S-parameters in different states of the lasagna, respectively.

### DETAILED DESCRIPTION OF THE PREFERRED EMBODIMENTS

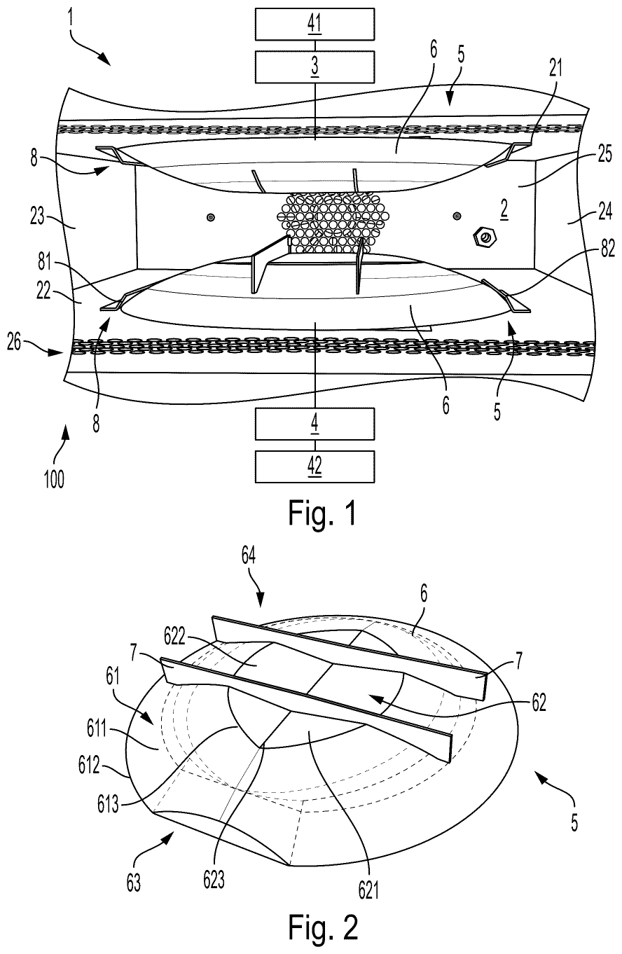

FIG. 1 exemplarily shows a preferred embodiment of a microwave oven 100 with a cavity 1 according to the present invention. The cavity 1 is designed to be used in a microwave oven. An exemplarily microwave oven is described below. The cavity 1 defines a space 2 for receiving a food product. The space 2 may be enclosed by one or more walls such as a top wall 21, a bottom wall 22, one or more (e.g. lateral) side walls 23, 24, and/or a back wall 25. The space 2 may be accessible via an opening 26 that may be opposite to the back wall 25.

The food product, which can be received by the space 2, may be any packaged or unpackaged food product. The package may be a sealed package. The material of the package may be any material transparent for microwaves. For example, PET may be used as a material of the package. The food product may comprise different components or ingredients (e.g. two or more components or ingredients). The components may have different conditions and/or different culinary qualities. For example, some components may be in a raw condition, whereas other components are in a prepared condition, e.g. already cooked or fried. The components may include carbs (rice, potato, etc.), vegetables, fruits and/or meat. In one example, the food product is a lasagna. The invention is, however, not limited to a specific food product or specific food components. The components of the food product may have different aggregate conditions, e.g. a frozen or defrosted condition. In one example, the food product is frozen. In other words, the invention is particularly useful for heating large frozen food products. The package may include one or more compartments (e.g. two or more compartments), wherein each of the compartments may receive a respective component.

The microwave oven 100 further comprises at least two solid state microwave sources 41, 42 for generating microwaves. Each of the solid state microwave sources 41, 42 is adapted to generate a respective microwave, having a defined frequency (preferably in a range from 800 to 1000 MHz, more preferably from 850 to 950 MHz, most preferably 915 MHz), amplitude and phase (angle). However, the process of the invention will work for any frequency, such as in the range from 2.4 to 2.5 GHz or for frequencies lower than 300 MHz. The at least two solid state microwave sources 41, 42 may also generate microwaves in other microwave bands, such as in a microwave band having a center frequency of 5.8 GHz or 433.92 MHz. In particular, the respective wavelength may be adjusted such that a higher penetration depth and larger spaces of high and low field intensity in the food product to be heated are effected. Each of the solid state microwave sources 41, 42 may comprise a respective electronic frequency generator (synthesizer) and a solid state amplifier for generating the respective microwave. Each of the solid state microwave sources 41, 42 may further comprise a power plug for supplying the solid state microwave source and its components with electric power. Preferably, the at least two solid state microwave sources 41, 42 are operated with a total power which is comprised from 800 W to 2000 W, preferably such that each solid state microwave source is operated with a power from 1200 W to 1800 W, preferably from 1400 W to 1600 W, most preferably with 1500 W.

A control unit (not shown) may be provided for controlling the solid state microwave sources 41, 42. In particular, the control unit is adapted to control/adjust the frequency, amplitude and phase of each of the microwaves to be generated by the solid state microwave sources 41, 42. The control unit may be an electronic control unit, e.g. provided on a computing unit. The control unit may be functionally connected to the solid state microwave sources by wire or wirelessly.

The microwave oven 100 further comprises two microwave emitters (channels) 3, 4 for coupling the microwaves generated by the solid state microwave sources 41, 42 into the space 2. The space 2 is arranged between the microwave emitter 3, 4. Each of the two microwave emitters 3, 4 may comprise a respective solid state microwave source 41 respectively 42. In some embodiments, each of the microwave emitters 3, 4 is connected to the respective solid state microwave source 41, 42 by way of a waveguide such as a cable, e.g. a coax cable, such that the microwaves generated by the solid state microwave sources can be fed into the microwave emitters 3, 4. In other embodiments, coax cables are avoided, e.g. in mass production. Each of the microwave emitters 3, 4 may emit microwaves with a power from 600 W to 900 W, preferably from 700 W to 800 W, most preferably with 750 W.

The microwave emitters 3, 4 may be provided opposite each other, in particular such that they diametrically oppose each other and/or directly face each other. In particular, in a plan view of the cavity 1, the microwave emitters 3, 4 may be provided congruently. Preferably, the first microwave emitter 3 is positioned at the top of the space 2, in particular at the top wall 21. The first microwave emitter 3 may be designed integrally with the top wall 21. Alternatively, the first microwave emitter 3 may be detachably connected/fastened to the top wall 21. The second microwave emitter 4 may be positioned at the bottom of the space 2, preferably at the bottom wall 22. The second microwave emitter 4 may be designed integrally with the bottom wall 22. Alternatively, the second microwave emitter 4 may be detachably connected/fastened to the bottom wall 22.

Each of the microwave emitters 3, 4 may be an antenna. The antenna may have a hollow form. Preferably, the antenna is a horn antenna. That is, the antenna may have the form of a horn, wherein the flaring or widening part of the horn antenna opens with its widened opening into the space 2. The microwave emitters 3, 4 may be designed identically, at least with respect to their forms.

The cavity 1 is preferably a single-mode microwave cavity. For example, the single-mode microwave cavity may be provided by the design of the microwave emitters 3, 4, such as of a (hollow) cross-section of the microwave emitters 3, 4. In particular, each of the microwave emitters 3, 4 may be designed to carry only a single mode of microwaves, e.g. by choosing a very narrow (hollow) cross-section of the respective microwave emitter 3, 4 so that via this cross-section only a specific mode of microwaves can be carried.

Preferably, the cavity 1 is designed such that no resonance mode occurs in the cavity 1 when excited by a frequency within the respective ISM band, e.g. in a range of 902-928 MHZ, and, preferably, when the food product 10 is arranged in the space 2.

The microwave oven 100 may further comprise one or more heating devices (not shown) arranged to transfer heat into the space 2 for heating the food product received therein. The one or more heating devices may be arranged to heat parts or regions of the food product, which cannot or at least be hardly reached and heated by emitted microwaves and/or which need to be provided by a different heating effect than the one achieved by microwaves; for example, this different heating effect may comprise a browning and/or crisping effect. These parts or regions of the food product are, for example, at the edge and/or periphery and/or rim of the food product. The one or more heating devices may be provided at a different position than the at least two microwave emitters 3, 4. For example, the one or more heating devices 8, 9 may be provided laterally with respect to the space 2, e.g. provided at the side walls 23, 24, respectively. For example, each of the side walls 23, 24 may comprise a respective opening, wherein the one or more heating devices are arranged to transfer the heat via these openings, respectively.

The two heating devices are preferably arranged opposite each other, i.e. facing each other. The two heating devices may be arranged to transfer heat along a direction that is inclined or perpendicular to the propagation direction of the emitted microwaves. As such, the transferred heat may reach locations in the space 2 and, thus, in the food product, which are different from the locations in the space 2 and, thus, in the food product, which the microwaves can reach.

The one or more heating devices may transfer heat into the space 2 in any suitable manner, such as by thermal convection and/or thermal radiation. Each of the one or more heating devices may transfer heat into the space 2, and thus to the food product, by introducing hot air into the space 2. In particular, each of the one or more heating devices may comprise an air flow device, such as a fan and/or a ventilation device, that delivers a current of (e.g. circulating) hot air into the space 2 for heating the food product received therein. The hot air then flows around the food product and transfers heat to the food product, e.g. for a browning effect on the surface of the food product. The one or more heating devices are, in particular, operated with electrical energy and/or can operate in a plurality of power states, such as in a deactivated state, an activated state, and, optionally, a further activated state.

The control unit may be further configured to control the one or more heating devices. As such, the control unit can control the heating with the solid state microwave sources 41, 42 and the one or more heating devices according to a defined control scheme which is, for example, electronically stored in the control unit. The control unit may thus advantageously combine the heating with the solid state microwave sources 41, 42 with the heating with the one or more heating devices so that a very quick and even heating, in particular defrosting, of the food product can be achieved. For example, the control unit can control the solid state microwave sources 41, 42 and the heating devices in such a way that one or more phases of heating with the solid state microwave sources 41, 42 are in sequence and/or in parallel with one or more phases of heating with the one or more heating devices.

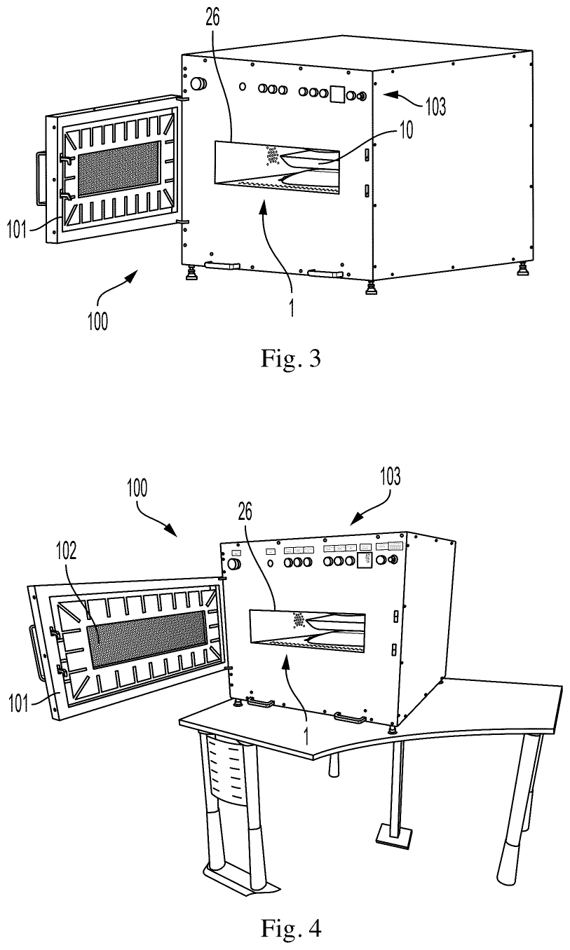

FIGS. 3 and 4 exemplarily show preferred embodiments of a microwave oven 100 comprising the previously described cavity 1. The microwave oven 100 may comprise a door 101 for selectively closing and opening the opening 26 of the cavity 1. In particular, the door 101 is designed for shielding against the escape of microwaves from the space 2 and/or against the escape of vapors and splashed greases and/or against the heat delivered by the one or more heating devices. The door 101 may comprise a window portion 102 for observing the space 2 and the food product received therein.

The microwave oven 100 may comprise a user interface 103 functionally connected with the control unit. The user interface 103 may facilitate inputting parameters of the control unit, which, in particular, relate to heating with the solid state microwave sources and/or the one or more heating devices. For example, the user interface may be configured to switch on and off the microwave oven 100 and cavity 1, respectively.

As shown in FIG. 1, the cavity 1, or microwave oven 100, comprises two redistributing elements 5, a first redistributing element 5 associated with the first microwave emitter 3 and a second redistributing element 5 associated with the second microwave emitter 4. In other embodiments, however, also more or less than two redistributing elements 5 may be provided, such as only one redistributing element 5 associated with the first microwave emitter 3 or the second microwave emitter 4. In the following, the redistributing element 5 associated with the second microwave emitter 4 is described in more detail. This description applies analogously to the redistributing element 5 associated with the first microwave emitter 3, unless otherwise indicated.

The redistributing element 5 is arranged to redistribute the microwaves emitted by the microwave emitter 4 into the space 2 towards one or more defined target areas of the space 2 and thus towards one or more defined target areas of the food product 10 arranged in the space 2, such as both to a central region and to one or more rim regions of the food product 10. Thereby, the food product 10 can be quickly heated, such as transferred from a frozen state into a cooked state, while achieving an even heat distribution throughout the food product 10. In particular, the redistributing element 5 may be arranged to redistribute the emitted microwaves so as to be focused and/or dispersed, such as fanned out, in the space 2. For example, a first defined target area in the space 2 may be exposed to the focused microwaves, e.g. such that these microwaves are absorbed by a central region of the food product 10 in the space 2, while a second defined target area in the space 2 may be exposed to the dispersed microwaves, e.g., g. such that these microwaves are absorbed by at least a rim region of the food product 10 in the space 2.

In particular, by using the redistributing element 5, the electric field can be shaped in such a way that the problem of the hot spot size is solved without causing excessive edge heating.

Being used in combination with a mono-mode (single-mode) oven, the redistributing element 5 offers additional control over the electric field. In such an oven, the cavity may designed such that reflected microwaves deviating from a specific direction (e.g. from a main vertical direction, which may be perpendicular to a side wall; such reflected microwaves may be referred to as “stray waves”) are limited. For example, walls (e.g. top and/or bottom walls) delimiting the cavity may be arranged such that emitted microwaves do not hit these walls. In particular, the cavity 1, or space 2, may be provided so as to be more a widened area within a waveguide with microwaves going in both vertical directions.

As shown in, e.g., FIG. 2, the redistributing element 5 may comprise, or may be, a lens 6. The lens 6 may comprise a convex section 61 for focusing microwaves emitted by the microwave emitter 4. Additionally, or alternatively, the lens 6 may comprise a concave section 62 for dispersing, such as fanning out, microwaves emitted by the microwave emitter 4. The convex section 61 may be arranged at least laterally with respect to the concave section 62 and/or may surround the concave section 62, such as in the form of a (e.g., circular, oval, rectangular, or polygonal) ring.

The lens 6 may comprise a backside 63 and a front side 64, wherein the front side 64 faces the space 2 and comprises the convex section 61 and/or the concave section 62. The backside 63 may be flat, which may be advantageous for manufacturing the lens 6 and/or attaching and detaching the lens 6.

The convex section 61 has a surface 611 that is preferably not flat but, for example, curved, when viewed in a cross-sectional view, e.g. a cross-sectional view parallel to a radial direction of the convex section. The convex section 61 may be delimited by an outer rim 612 and an inner rim 613, wherein the outer rim may be the outer rim, or outer circumference, of the lens 6. The inner rim 613 may delimit the convex section 61 from the concave section 62. Preferably, the rims 612, 613 are arranged on different levels.

The concave section 62 may comprise, or consist of, two sub sections 621, 622, which may be flat, e.g. with two flat outer surfaces, respectively. The sub sections 621, 622 may be inclined with respect to one another, e.g. at an angle greater than 90°, preferably greater than 135°, more preferably greater than 150°. The sub sections 621, 622 may form a (straight) groove 623, which may be on a lower level than at least part of the inner rim 613. The sub sections 621, 622 may be delimited by the inner rim 613.

The lens 6 may be plane symmetric, such as plane symmetric with respect to a symmetry plane extending through a center of the concave section 62. For example, the symmetry plane may extend between the sub sections 621, 622 and/or parallel to the groove 623. Another symmetry plane may extend perpendicularly with respect to the groove 623.

The cavity 1, or microwave oven 100, may comprise a spacer 7 arranged to provide a defined distance between the redistributing element 5 and a food product 10 arranged within the space 2. For example, the spacer 7 may be provided such that the food product 10 can be arranged on the spacer 7 for being heated within the space 2. As such, no other elements (such as a tray or support) may be arranged between the spacer 7 and the food product 10, whereby a particularly compact cavity 1 can be provided. Preferably, the spacer 7 is arranged only on the (lower) redistributing element 5 associated with the second microwave emitter 4. In other words, the (upper) redistributing element 5 associated with the first microwave emitter 3 may be void of a spacer 7.

The spacer 7 may be connected to, and/or received by, the redistributing element 5. For example, the redistributing element 5 comprises a recess in which the spacer 7 is arranged. The spacer 7 may comprise two spacers 7, which may extend parallel to one another. The spacer 7 may have an elongate and/or plate-like form. The spacer 7 may extend both in the convex section 61 and in the concave section 62. The spacer 7 may extend transversely, such as perpendicularly, with respect to the groove 623.

The redistributing element 5 is not limited to a specific material. Preferably, the redistributing element 5 is not made of metal. The redistributing element 5 may be made of plastic. The redistributing element 5 may be made of a microwave transparent material, such as a microwave transparent plastic and/or a ceramic or glass material.

As shown in FIG. 1, the cavity 1, or microwave oven 100, may comprise a support 8 on which the redistributing element 5 is detachably arranged. The support 8 may be attached (e.g. permanently, such as by welding) to the bottom wall 22. The support 8 for the other redistributing element 5 may be attached to the top wall 21. The support 8 may be designed to facilitate an attachment, or detachment, of the redistributing element by a sliding movement. The sliding movement may be along a direction parallel to the bottom wall 22. The support 8 may comprise one or more guide rails 81, 82. The one or more guide rails 81, 82 may be arranged such that at least part of the convex section 61 (such as at least the outer rim 612) can be received by, and guided in, the guide rails 81, 82. The guide rails 81, 82 may extend parallel to one another and/or may be respectively a bent piece.

The control unit may be configured to control the solid state microwave sources 41, 42 to operate in different, consecutive phases with different powers, respectively. For example, the control unit may be configured a) to switch the solid state microwave sources into an activated state comprising the different phases, and b) to switch the solid state microwave sources into a deactivated state upon the lapse of at least 13 min (such as of at least 14 min) and/or not more than 20 min (such as not more than 19 min, e.g. upon the lapse of about 18 min, after the switch into the activated state. In the deactivated state, the food product may be sufficiently heated and cooked by the use of the microwaves emitted in the activated state.

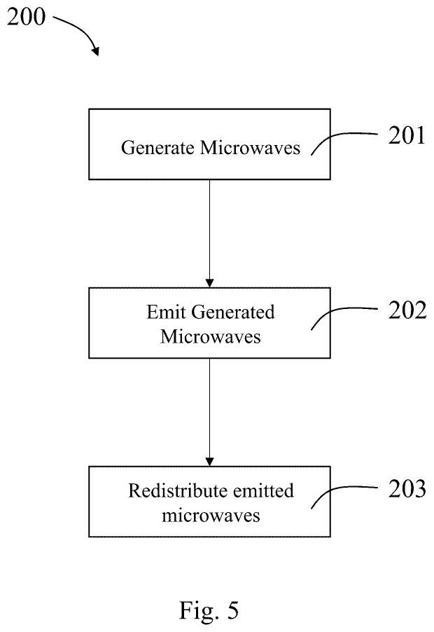

FIG. 5 shows an embodiment of a method 200 for heating a food product such as a lasagna, e.g. by using the cavity 1 or microwave oven 100 as described above. The method comprises the following (consecutive) steps: in step 201, generating, by two solid state microwave sources 41, 42, microwaves; in step 202, emitting, by two microwave emitters 3, 4, the microwaves generated by the solid state microwave sources 41, 42; and, in step 203, redistributing, by a redistributing element 5, the microwaves emitted by at least one of the microwave emitters towards one or more defined target areas of the food product 10.

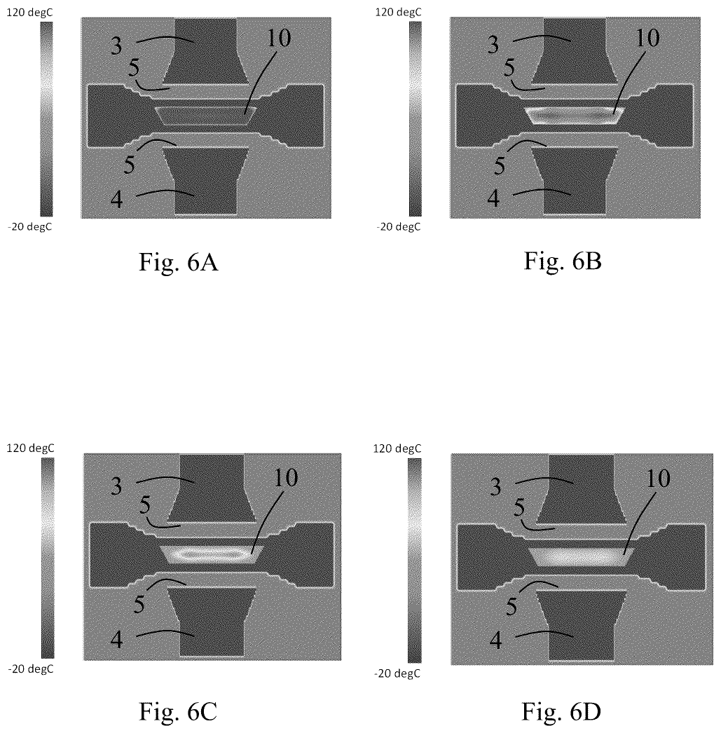

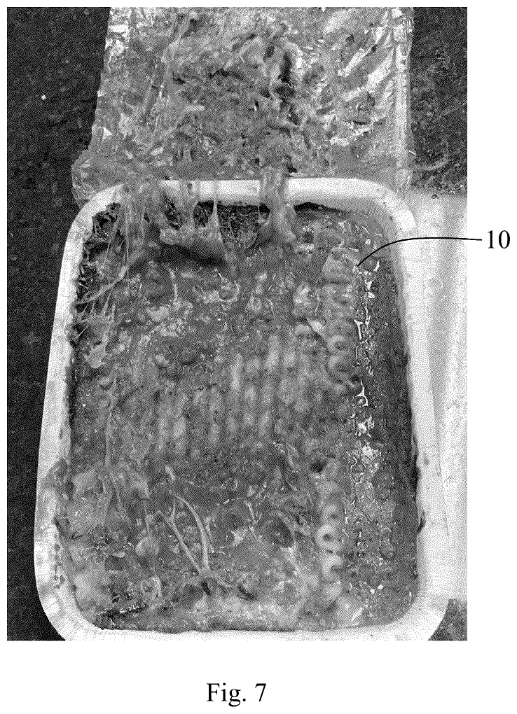

FIGS. 6A-6D show an example in which a food product 10 is heated by using the microwave oven 100, or cavity 1, as described above. The temperature distributions are shown at four different times during the heating by using the microwaves, (a) after 5 min, (b) after 10 min, (c) after 15 min, (d) after 20 min. After 5 min of microwaves exposure, as shown in FIG. 6A, the microwaves redistributed by the redistributing element(s) 5 already began to heat a central region and rim regions of the food product 10, as can be derived from the higher temperatures in these regions compared to other regions of the food product. After 10 min of microwaves exposure, as shown in FIG. 6B, the hot rim region extends even further towards the core of the food product. After 15 min of microwave exposure, as shown in FIG. 6C, the temperature distribution in the food product 10 is already sufficient for consumption. After 15 min of microwave exposure and 5 min rest time, as shown in FIG. 6D, all regions of the food product 10 have substantially the same temperature.

To provide a particularly successful heating of the lasagna, the lasagna may be turned, e.g. by a turning mechanism (such as a microwave transparent table or a gripper), in the space by a defined angle, such as 90°. This turning may be (e.g. automatically by using the control unit) between phases 4 and 5 about the height axis of the cavity 1 or microwave oven 100.

The cavity 1 may be a non-resonant cavity. This means that the cavity 1 is preferably designed such that microwaves emitted by the microwave emitter 3, 4 are not reflected by any of the walls (in particular the top and bottom walls 21, 22) delimiting the space 2. This avoids that in the space 2 microwaves bounce back and forth between the walls. Accordingly, it is avoided that at the cavity's 1 resonant frequencies the reflected microwaves and the emitted microwaves reinforce to form standing waves in the cavity 1 or space 2. Thus, the cavity 1 is preferably designed that no such standing waves are formed therein. If there are standing waves in the cavity 1 or space 2, they are created only by the interference of the microwaves from the two solid state microwave sources 41, 42.

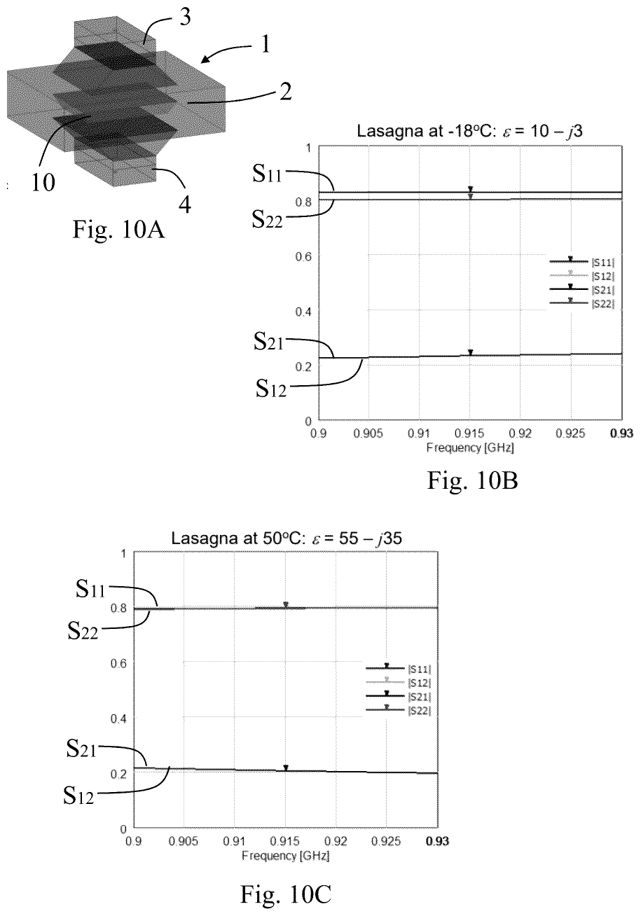

FIGS. 10B and 10C show the amounts of the S-parameters (scattering parameters) of a network including the cavity 1 and a food product 10 (e.g. a lasagna) being heated therein. FIG. 10B is for a first state of the lasagna (frozen state), while FIG. 10C is for a second state of the lasagna (already heated to a temperature of about 50° C.). FIG. 10A shows the cavity 1 with the food product 10 arranged therein and the two microwave emitters 3, 4. As shown in FIGS. 10B and 10C, the amounts of the reflection coefficients (S11 and S22) and the amounts of the transmission coefficients (S12 and S21) remain substantially constant for different frequencies of the emitted microwaves, in particular in a range of 0.9-0.93 GHZ.

### EXAMPLE

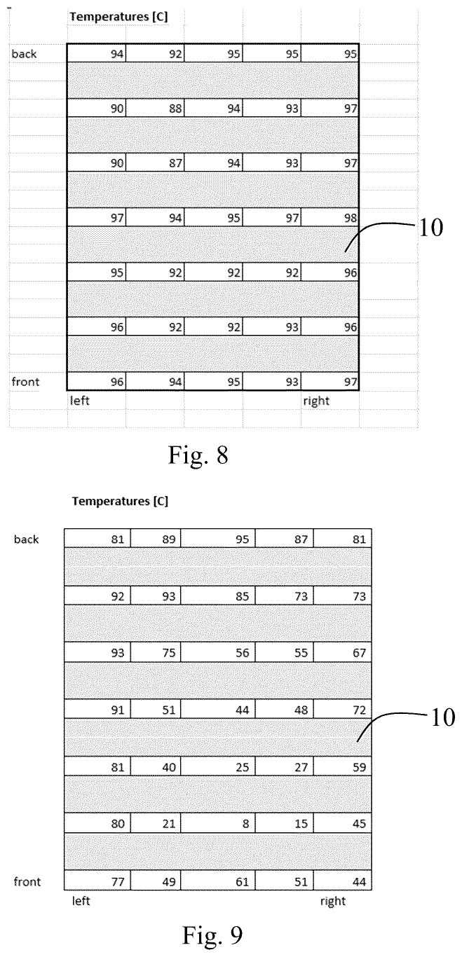

With respect to FIGS. 7 and 8, an example in which an initially frozen food product 10, namely a lasagna (family size, i.e. 1060 g) is heated and thus cooked by using the microwave oven 100 is described. In this example, the food product 10 is exposed to five different heating phases as indicated in the following table. Phase angle=0 is defined by a constructive interference (i.e. hot spot) occurring in the middle of the space between the emitters.

| | | | | Phase | | | |
|---|---|---|---|---|---|---|---|
| | from | to | Microwave | Angle | Air Temp | Air | |
| | [min] | [min] | Power [W] | [deg] | [° C.] | Velocity | Bleed Air |
| Phase 1 | 0 | 2 | 800 | 0 | 150 | off | closed |
| Phase 2 | 2 | 4 | 1000 | 0 | 150 | off | closed |
| Phase 3 | 4 | 6 | 1200 | 0 | 150 | off | closed |
| Phase 4 | 6 | 10 | 1600 | 0 | 150 | max | closed |
| Phase 5 | 10 | 15 | 1400 | 0 | 150 | max | closed |

As shown, the control unit controlled the solid state microwave sources such that they operate in the different phases with different microwave powers and such that, beginning with Phase 4, a current of air is introduced into the space 2. The microwave oven is pre-heated to 150° C. (see column “Air Temp”). In phase 1, the lasagna is so transparent that the microwaves go through to a large extent and end up as a burden on the other channel (microwave emitter). Thus, to protect the transistors of the microwave sources, phase 1 uses less power with respect to the other phases.

The resulting food product 10 at the end of Phase 5, is shown in FIG. 7. Temperatures were taken at several positions on the mid level of the lasagna, i.e. at about the lasagna's center with respect to its height. The corresponding readings are shown in FIG. 8. As shown, the lasagna has a substantially even temperature distribution from its front to its back and from its left side to its right side. The temperature distribution is in particular such that the lasagna is safe for consumption. The slight asymmetry in the temperature distribution is probably owed to an uneven filling level of the frozen product.

### COMPARATIVE EXAMPLE

The example (see above) was repeated except that the two redistributing elements (lenses) were taken out of the oven 100, and that the family size lasagna was placed on two pressed paper trays so that it was in the same position as in the example using the redistributing elements; the paper trays are considered neutral in terms of microwave effect.

At the end of Phase 5, temperatures were taken at several positions on the mid level of the lasagna, i.e. at about the lasagna's center with respect to its height. The corresponding readings are shown in FIG. 9. As shown, several areas clearly did not receive enough power, resulting in an uneven temperature distribution. It was also observed that the amount of reflected power was much higher throughout the process than it has been with the example using the redistributing elements (lenses).

In sum, by using the microwave oven according to the invention, a ready to consume food product, such as a lasagna, can be obtained (e.g. from a frozen state) in a particularly easy and convenient manner. For example, a consumer places an order for a hot lasagna and is able to pick it up 15 min later, which is advantageous over other ovens where the wait time would probably be 25 min or more. Alternatively, the lasagna would have to be cooked from chilled temperature or in advance without knowledge of the future demand. Both alternatives are problematic in terms of demand planning, which is why it is desirable to cook from a frozen state.

The microwave oven is not limited to a specific configuration. For example, the microwave oven can be provided in at least two different configurations, e.g. as a stand-alone food service type oven (e.g. for being placed on a tabletop) or as part of a vending machine.

1. A microwave oven for heating a food product, comprising:
two solid state microwave sources configured to generate microwaves;
two microwave emitters configured to emit the microwaves generated by the solid state microwave sources;
a cavity defining a space for receiving the food product, the space being disposed between the microwave emitters; and
at least one redistributing element configured to redistribute the microwaves emitted by at least one of the microwave emitters into the space towards one or more defined target areas within the space.

2. The microwave oven according to claim 1, wherein the cavity is configured such that the microwaves generated by the solid state microwave sources do not resonate within the ISM band in the range of from 902 MHz to 928 MHz.

3. The microwave oven according to claim 1, wherein each redistributing element comprises at least one of a non-metallic material and a microwave transparent material.

4. The microwave oven according to claim 1, wherein each redistributing element is configured to redistribute the emitted microwaves in at least one of a focused manner and a dispersed manner in the space.

5. The microwave oven according to claim 1, wherein each redistributing element comprises a lens.

6. The microwave oven according to claim 5, wherein the lens comprises:
a convex section configured to focus microwaves emitted by the at least one of the microwave emitters, and
a concave section configured to disperse microwaves emitted by the at least one of the microwave emitters.

7. The microwave oven according to claim 6, wherein the lens further comprises a back side and a front side;
wherein the front side faces the space and comprises the convex and concave sections; and
wherein the backside is flat.

8. The microwave oven according to claim 6, wherein the convex section is arranged at least one of laterally with respect to the concave section and surrounding the concave section.

9. The microwave oven according to claim 6, wherein the concave section comprises two sub sections, the sub sections being inclined with respect to one another at an angle greater than 90°.

10. The microwave oven according to claim 5, wherein the lens is plane symmetric.

11. The microwave oven according to claim 1, further comprising a spacer configured to space the at least one redistributing element from the food product disposed within the space.

12. The microwave oven according to claim 1, wherein the at least one redistributing element comprises two redistributing elements, the redistributing elements each being arranged to redistribute the microwaves emitted by one of the microwave emitters into the space towards the one or more defined target areas of the space.

13. The microwave oven according to claim 1, further comprising a support on which the at least one redistributing element is detachably arranged, the support comprising at least one guide rail.

14. The microwave oven according to claim 1, further comprising a heating device configured to transfer heat into the space.

15. The microwave oven according to claim 1, further comprising a control unit configured to control the solid state microwave sources; and
wherein the control unit is configured to control the solid state microwave sources to operate in different, consecutive phases with at least one of different powers and different phase angles.

16. The microwave oven according to claim 15, wherein the control unit is configured to adjust a phase angle between the microwaves emitted by one of the solid state microwave sources and the microwaves emitted by the other one of the solid state microwave sources.

17. The microwave oven according to claim 1, further comprising a turning mechanism configured to turn the food product in the space by a defined angle.

18. A kit, comprising:
a microwave oven comprising:
two solid state microwave sources configured to generate microwaves;
two microwave emitters configured to emit the microwaves generated by the solid state microwave sources;
a cavity defining a space for receiving the food product, the space being disposed between the microwave emitters; and
at least one redistributing element configured to redistribute the microwaves emitted by at least one of the microwave emitters into the space towards one or more defined target areas within the space; and
a plurality of interchangeable redistributing elements for generating heating patterns.

19. A method for heating a food product, the method comprising:
generating microwaves via two solid state microwave sources;
emitting the microwaves generated by the solid state microwaves via two microwave emitters; and
redistributing the microwaves emitted by at least one of the microwave emitted toward one or more defined target areas of the food product via at least one redistributing element.
